(19) United States
(12) Patent Application Publication
(10) Pub. No.: US 2008/0124969 A1
(43) Pub. Date: May 29, 2008

(54) Method and apparatus for determining the orientation of a display monitor utilizing a device independent of the monitor

(75) Inventor: Kenneth Walker, Canyon, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/605,734

(22) Filed: Nov. 29, 2006

(51) Int. Cl. H01R 3/00

(52) U.S. Cl. 439/489

(57) ABSTRACT

A device for sensing an orientation of a screen portion of a monitor is disclosed, and includes a body, a first connector located on the body and configured to connect to a connector on a screen portion of a monitor, a second connector located on the body and configured to connect to a connector on a cable, and an orientation sensing device mounted on the body and configured to sense an orientation of the body such that the orientation sensing device senses an orientation of the screen portion of the monitor when the first connector is connected to the connector on the screen portion of the monitor.

### BACKGROUND OF THE INVENTION

1. Field of the Invention

The present invention relates to detection of the orientation of display monitors, and more particularly pertains to a new method and apparatus for determining the orientation of a display monitor that utilizes a device that is independent of the monitor to detect and signal the orientation of the monitor.

2. Description of the Prior Art

The increasing availability and decreasing cost of monitors with a significantly reduced cabinet depth (typically referred to as “flat panel” monitors) has led to a corresponding increase in the popularity of such monitors. Flat panel monitors typically employ Liquid Crystal Diode (LCD) screens (although other technologies are also employed for the screen), and the LCD screens are relatively much thinner in cabinet depth than previous monitors based upon cathode-ray tube (CRT) screens. This characteristic permits the use of the monitors in ways that were not generally possible with the heavier and bulkier CRT screens.

One practice made practical by the use of flat panel monitors is the rotating or tilting of the screen about an axis oriented substantially perpendicular to the surface of the display screen. The display screen may thus be rotated from the more traditional “landscape” orientation (in which the relatively longer dimension of the screen is oriented horizontally) to the “portrait” orientation (in which the relatively longer dimension of the screen is oriented substantially vertically). This change of orientation may be desirable, for example, for making the height and width dimensions of the screen more accurately match the height and width of the final form of the matter being displayed, such as, for example, the text of a letter to be printed on a letter-sized sheet of paper.

Not surprisingly, a change in the orientation of the screen requires a change in the video signal being sent to the monitor by the circuitry generating the video signal, otherwise the image displayed on the screen would be rotated approximately 90 degrees (or more) from the normal or desirable orientation of the image with respect to the viewer. Typically, the change in orientation of the screen is signaled to the video generating circuitry (such as a video graphics card or a graphics chip integrated on a motherboard) by the user manually signaling the computer that a change in the orientation has occurred, and indicating the new position of the screen. This has been accomplished, for example, by the use of one or more hot key combinations on the keyboard or a user-actuated icon on a graphical user interface (GUI). More recently, some monitors have been designed with a position or orientation sensor that is integrated into the cabinet of the monitor, and the sensor signals to the video generating circuitry information about the orientation.

However, these approaches either require the user to remember the necessary orientation signals (e.g., hot keys) to use on the system (and then requires the user to provide the appropriate signal at each change of the orientation), or requires the user to purchase a monitor with the specialized position sensing circuitry integrated in the monitor cabinet to signal the video generating circuitry itself. While the latter option is more convenient, the additional expense of the circuitry means that only more expensive monitors are available with this feature, and also that this position sensor cannot be added or retrofitted to existing monitors.

It is therefore believed that a need exists in the art for a system that senses the orientation of a monitor and signals the video generating circuitry without requiring user action or intervention, but does not require the complete replacement of the monitor to obtain this capability.

### SUMMARY OF THE INVENTION

The present invention provides a new apparatus for determining the orientation of a display monitor that utilizes a device that is independent of the monitor to detect and signal the orientation of the monitor, and a method for utilizing the new apparatus.

In one aspect of the invention, a device is provided for sensing an orientation of a screen portion of a monitor comprising a base portion and the screen portion pivotally mounted on the base portion to permit pivoting of the screen portion with respect to the base portion. The device comprises a body, a first connector located on the body and configured to connect to a connector on the screen portion of the monitor, and a second connector located on the body and configured to connect to a connector on a cable. The second connector is in communication with the first connector. The device may also include an orientation sensing device mounted on the body and configured to sense an orientation of the body such that the orientation sensing device senses an orientation of the screen portion of the monitor when the first connector is connected to the connector on the screen portion of the monitor.

In another aspect of the invention, an information handling system is provided that is capable of sensing an orientation of a screen displaying video generated by the system. The system may include a monitor comprising a base portion and a screen portion having a display screen, with the screen portion being pivotally mounted on the base portion to permit pivoting of the screen portion with respect to the base portion. The monitor may have a monitor connector for receiving video signals. The system also may include video generating circuitry configured to generate a video signal to produce images on the display screen of the monitor. The system may further include a cable configured to carry a video signal, and being in electrical communication with the video generating circuitry, for receiving a video signal from the video generating circuitry. The cable has a cable connector configured to connect to the monitor connector of the monitor. The system also includes a device for sensing an orientation of the screen portion of the monitor. The device may comprise a body, a first connector located on the body and connected to the monitor connector on the screen portion of the monitor, and a second connector located on the body and connected to the cable connector on the cable, with the second connector being in electrical communication with the first connector for passing the video signal therebetween. The device also includes an orientation sensing device mounted on the body and configured to sense an orientation of the body such that the orientation sensing device senses an orientation of the screen portion of the monitor when the first connector is connected to the connector on the screen portion of the monitor.

In yet another aspect of the invention, a method is provided for sensing an orientation of a display screen on a monitor having a base portion and a screen portion pivotally mounted on the base portion. The method may comprise providing an apparatus comprising a body, a first connector located on the body, a second connector located on the body and being in electrical communication with the first connector, and an orientation sensing device mounted on the body and configured to sense an orientation of the body. The method may further comprise connecting the first connector of the apparatus to a connector on the screen portion of the monitor, connecting the second connector of the apparatus to a connector on a cable, sensing a position of orientation of the screen portion of the monitor and generating a position signal, and communicating the position signal to video generating circuitry configured to generate a video signal.

The foregoing is a general outline of the more significant elements or features of the invention, and the detailed description of this application that follows discloses additional features of the invention which form the subject matter of the claims appended hereto.

One significant aspect of the present invention is the ability to sense the orientation of a display screen and signal that change to video generating circuitry without requiring the user of the monitor to provide an indication (such as, for example, by manual means) of the change to an new portion. This capability can be achieved without having to procure a specialized monitor having this capability integrated into the monitor.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic rear view of a monitor with the screen portion thereof positioned in a landscape orientation and having the apparatus of the present invention connected thereto.

FIG. 2 is a schematic rear view of a monitor with the screen portion thereof positioned in a portrait orientation and having the apparatus of the present invention connected thereto.

FIG. 3 is a schematic perspective view of one embodiment of the present invention.

FIG. 4 is a schematic diagrammatic depiction of one optional configuration of the present invention.

FIG. 5 is a schematic diagrammatic depiction of another optional configuration of the present invention.

FIG. 6 is a schematic diagrammatic depiction of another optional configuration of the present invention.

FIG. 7A is a schematic front view of a monitor with the screen portion of the monitor in the landscape orientation.

FIG. 7B is a schematic front view of a monitor with the screen portion of the monitor in the portrait orientation.

FIG. 8 is a schematic perspective view of an optional embodiment of the invention.

### DESCRIPTION OF PREFERRED EMBODIMENTS

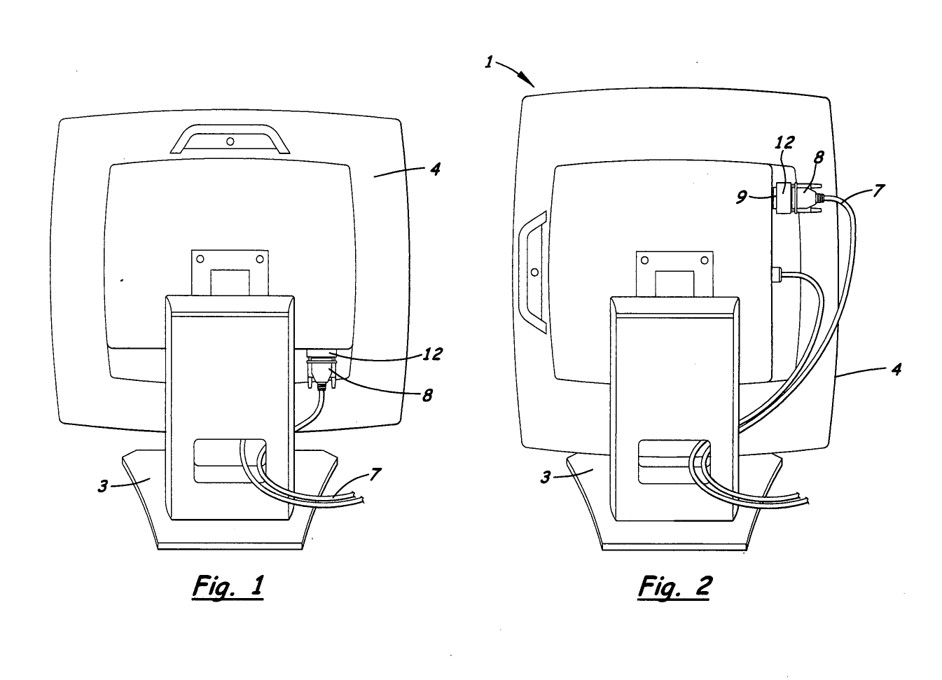

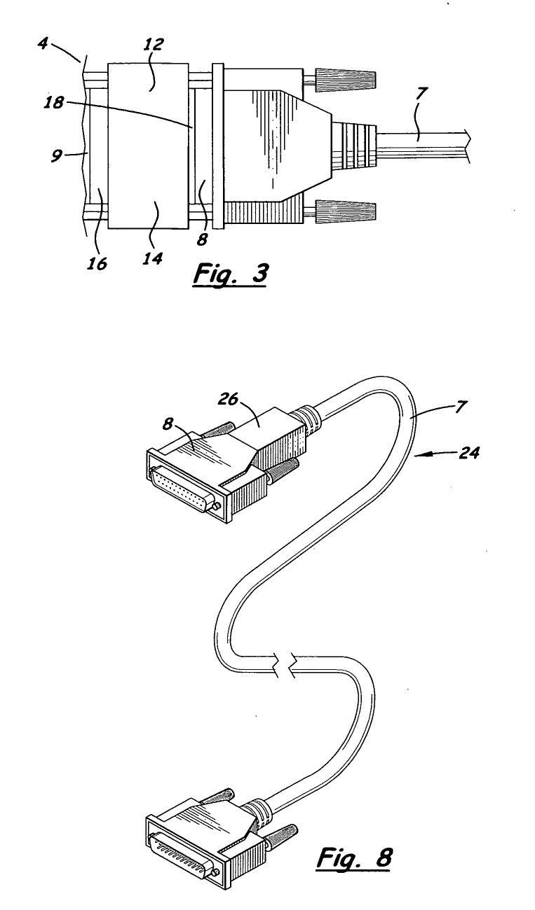

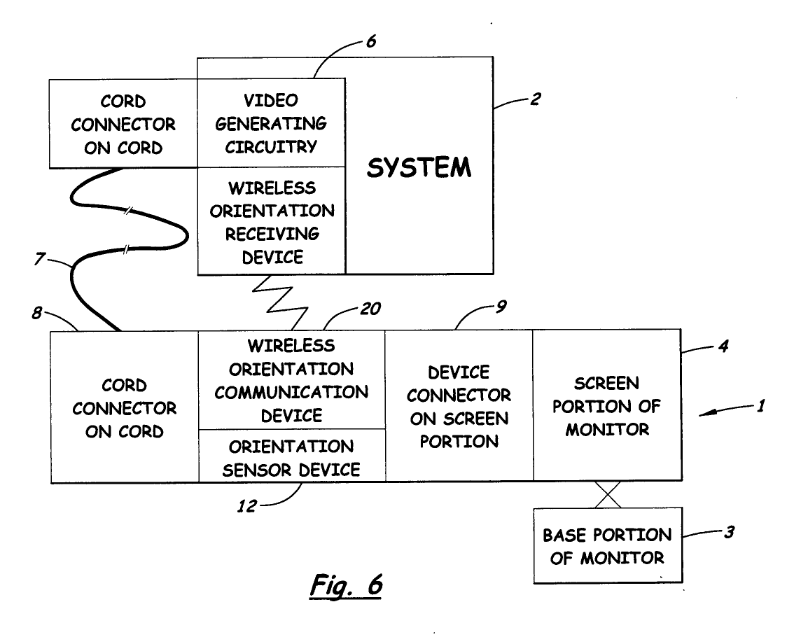

With reference now to the drawings, and in particular to FIGS. 1 through 8 thereof, the apparatus for determining the orientation of a display monitor, utilizing a device independent of the monitor, of the present invention is generally designated by the reference numeral 10 in this description.

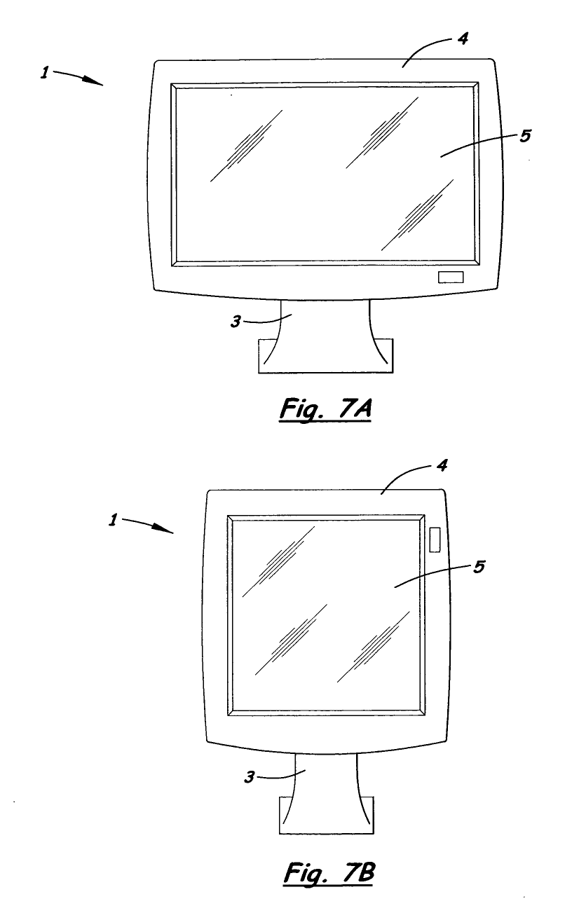

Initially, it should be recognized that while the invention may be employed with a number of different types of systems or appliances in which it may be desirable to determine some aspect of orientation, the method and system disclosed in this specification and drawings is highly suitable for use with video display apparatus, such as video monitors 1 that are used with information handling systems 2, such as personal computers, that generate or process the video signals for the video images to be displayed on the video display apparatus. A monitor 1 typically includes a base portion 3 that rests on a surface, and a screen portion 4 mounted on the base portion that includes the display screen 5 of the monitor. Monitors that are tiltable or rotatable between a landscape orientation (see FIG. 7A) and a portrait orientation (see FIG. 7B) typically have the screen portion 4 of the monitor 1 pivotally or rotatably mounted on the base portion 3 so that the screen portion 4 rotates about an axis that is oriented substantially perpendicular to the plane of the display screen 5, which permits rotation of the screen portion 4 between the landscape and portrait orientations.

Monitors 1 are typically connected to video generating circuitry 6 of an information handling system 2 through a cable 7 that passes video signals from the video generating circuitry 6 to the circuitry of the monitor 1 for displaying video on the display screen 5. The cable 7 may include a plurality of conductors for passing signals and/or power to the monitor 1, and has opposite ends. The cable is of the type that is configured to carry video signals to the monitor from the video generating circuitry. The cable 7 may have a first end that is configured to removably connect to the screen portion of the monitor. To accomplish this connection, the first end of the cable 7 may have a connector 8 for releasably connecting to a complementary connector 9 on the monitor 1. The particular orientation of the connector 9 on the monitor 1 is not standardized, and thus may vary from monitor to monitor, but it is believed that many if not most monitors include a connector 9 that is positioned on the housing of the monitor such that the conductor pins of the connector 9 extend generally downwardly toward a bottom of the monitor 1 when the screen portion 4 of the monitor 1 is in the landscape orientation. The monitor connector 9 is typically a female type connector with a plurality of sockets. The cable connector 8 is complementary to the monitor connector 9, and is generally a male type connector with exposed connector pins for removably inserting into the sockets of the monitor connector 9. The cable 8 and monitor 9 connectors may be connectors that are suitable for passing video signals, and the video connectors may be any suitable type, such as, for example, video graphics adapter (VGA), digital video interface (DVI), high definition media interface (HDMI). It will be recognized by those of ordinary skill in the art that other types of cables and connectors currently known or developed in the future for passing data or video data may be employed.

The orientation sending and signaling apparatus 10 for the monitor may be mountable on the monitor 1, and more specifically on the screen portion 4 of the monitor, in a manner that permits the apparatus 10 to sense the orientation of the screen portion 4 of the monitor when the apparatus 10 is connected to the monitor. In some embodiments of the invention, the apparatus 10 is positioned “in-line” of the monitor 1 and the cable 7, so that the apparatus 10 is positioned between the monitor connector 9 and the cable connector 8. In this embodiment, the apparatus 10 is configured to pass the video signals from the cable 7 and the cable connector 8 to the monitor connector 9 and the monitor 1.

The sending and signaling apparatus 10 may include a body 14 with a first connector 16 that is located on the body 14, and a second connector 18 that is also located on the body 14. The first connector 16 may be configured to connect both physically and electrically with the monitor connector 9, and thus may have a male pin configuration. The second connector 18 may be configured to connect both physically and electrically with the cable connector 8, and thus may have a female socket configuration. Suitable conductors may be provided in the body 14 to electrically connect the conductors of the first 16 and second 18 connectors to pass the video signals between the connectors and maintain continuity between the cable 7 and the monitor 1.

The orientation sensing and signaling apparatus 10 may also include an orientation sensing device 12 that is mounted on, or physically apart of, the body 14 of the apparatus 10 so that when the apparatus 10 is mounted on the monitor connector 9, the orientation sensing device 12 is moved with the screen portion 4 of the monitor 1 to thereby be capable of detecting the orientation of the display screen 5 when it is rotated.

The orientation sensing device 12 may be configured to sense at least two positions of rotation of the screen portion 4 about an axis extending into a plane defined by the surface of the display screen 5 of the screen portion 4. Orientation sensing devices suitable for use in this invention need only sense rotation or tilt about this single axis perpendicular to the plane of the display screen of the monitor. A first rotational position may correspond to the landscape position (see FIG. 7A) of the screen portion 4 of the monitor 1, and a second rotational position may correspond to the portrait position (see FIG. 7B) of the screen portion 4. Thus, a suitable orientation sensing device 12 may have a range of sensing positions of approximately 90 degrees, although a greater range of position sensing may be employed, particularly if clockwise and counterclockwise rotation of the screen portion 4 from, for example, a landscape orientation is desired to be supported. Consequently, additional rotational positions of the screen portion 4 may also be sensed, although sensing of the portrait and landscape positions is believed to be the most useful.

The orientation sensing device 12 includes suitable circuitry for sensing and communicating the sensed orientation of the device 12, and thus the connector 9, and thus the screen portion 4 on which the apparatus 10 is connected. The circuitry of the orientation sensing device 12 may be suitably powered in a variety of ways, including drawing power from one of the conductors extending through the apparatus 10 between the first 16 and second 18 connectors, or drawing power from a replaceable battery or a rechargeable battery mounted on the body 14, or even drawing power from the monitor itself through some type of interface with the monitor circuitry.

With respect to the technology employed for the orientation sensing device 12, the concept of the invention is not specific to, and thus limited to, any one type of orientation sensing technology. Those skilled in the art will recognize that there are a number of suitable orientation sensing devices available, and other orientation sensing devices are likely to be developed that will be suitable for use with the invention, and thus it is believed that the invention is not limited only to those orientation sensing devices presently known. For example, known sensor technologies for tilt sensors and inclinometers employ accelerometer, capacitive, electrolytic, mercury, and pendulum technologies. Accelerometers generally measure and analyze acceleration and vibration. Capacitive tilt sensors can produce noncontact measurements of tilt and inclination. Electrolytic tilt sensors may produce extremely accurate pitch and roll measurements. A mercury type tilt sensor typically includes a small metal or glass can enclosing two electrodes and a minute drop of mercury (operation is then based on the tilted position of the sensor—movement of the mercury towards the electrodes closes the circuit, and movement away from the electrodes opens the circuit). A pendulum type sensor is a pendulum or weight employed in conjunction with a rotary sensor.

Electrical outputs for inclinometers and tilt sensors may include analog current, digital (TTL), analog frequency or pulse, analog voltage, serial, parallel, and switched or alarm. As further discussed below, a suitable orientation device and supporting circuitry generates a position signal that may be received and analyzed by circuitry within the information handling system. Suitable signal generation from the orientation sensing device 12, or circuitry associated with the orientation sensing device, is within the capabilities of one of ordinary skill in the art without undue experimentation, and will not be further described here.

The position signal generated by the orientation sensing device 12 is indicative of the position of the screen portion 4 of the monitor 1. In some embodiments of the invention, the position signal transmitted to the video generating circuitry 6 may provide a positive indication of the current orientation of the screen portion 4 of the monitor. For example, the position signal transmitted may indicate “landscape” or “portrait” or some other discrete position of the monitor. Optionally, the position signal transmitted to the video generating circuitry 6 may simply indicate a change in the orientation of the screen portion of the monitor. For example, the position signal may simply indicate a change from the last known position to a different position, which would thus work best for monitors with only two positions. As a further option, the position signal may indicate a change to a more specific degree, such as indicating a number of degrees of rotation during the change. Of course, other variations in the manner in which the position is signaled to the video generating circuitry may be employed.

The orientation sensing and signaling apparatus 10 of the invention may also include an orientation communication device 20 for communicating information regarding the orientation of the screen portion 4, such as the position signal, to the information handling system 2. In some embodiments, the position signal is communicated by the orientation communication device 20 to the video generating circuit 6 of the information handling system 2. The video generating circuitry 6 may be incorporated in a video graphics card, or to graphics circuitry integrated into other elements such as the motherboard of the information handling system 2, or to any other device that generates, or communicates with circuitry that generates, the video signal sent to the monitor 1 via the cable 7. The video graphics card may conform, for example, to standards such as peripheral component interconnect (PCI), advanced graphics port (AGP) and PCI-express, as well as graphics cards and/or circuitry conforming to standards now known or that will be developed in the future.

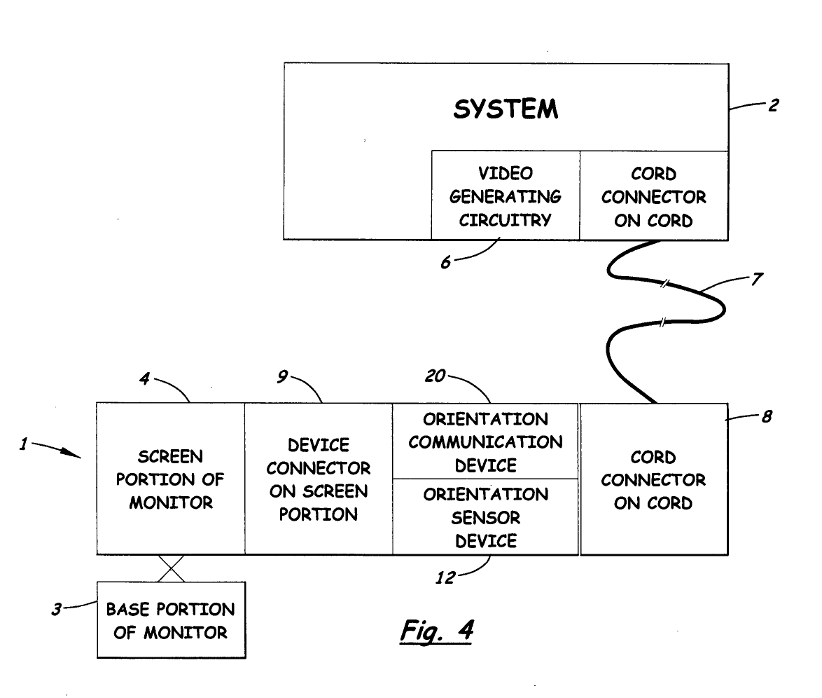

In some embodiments of the orientation communication device 20, a conductor of the cable 7 may be employed as the means of communication to carry the position signal from the orientation sensing device 12 to the video generating circuitry 6 (see, e.g., FIG. 4). In such implementations, the position signal may be communicated to, for example, a graphics card forming a portion of the video generating circuitry 6 using one of the conductors of the cable 7 that carries the video signals that is capable of carrying signals in a bidirectional manner. The conductor of the cable 7 that is employed may be one of the conductors or lines that is typically used for communicating data over the cable, or may be one of the conductors or lines that is typically unused in normal video transmission mode. Optionally, the position signal may be communicated on the Display Data Channel (DDC), which is a Video Electronics Standards Association (VESA) standard for communication between a monitor and a graphics card or video adapter. For example, these embodiments may be implemented with a specialized graphics card or graphics circuitry resident on the motherboard that are capable of recognizing and processing a position signal received through one of the conductors of the cable. As another example, these embodiments may be implemented with graphics circuitry (either onboard or on a separate card) that is not specialized, but includes a specialized driver or firmware that is capable of recognizing the position signal and causing the appropriate change in the video signal sent to the monitor 1 for display. Thus, the processing of the position signal may be limited to the video generating circuitry, or may be handled by the central processing unit of the information handling system 2.

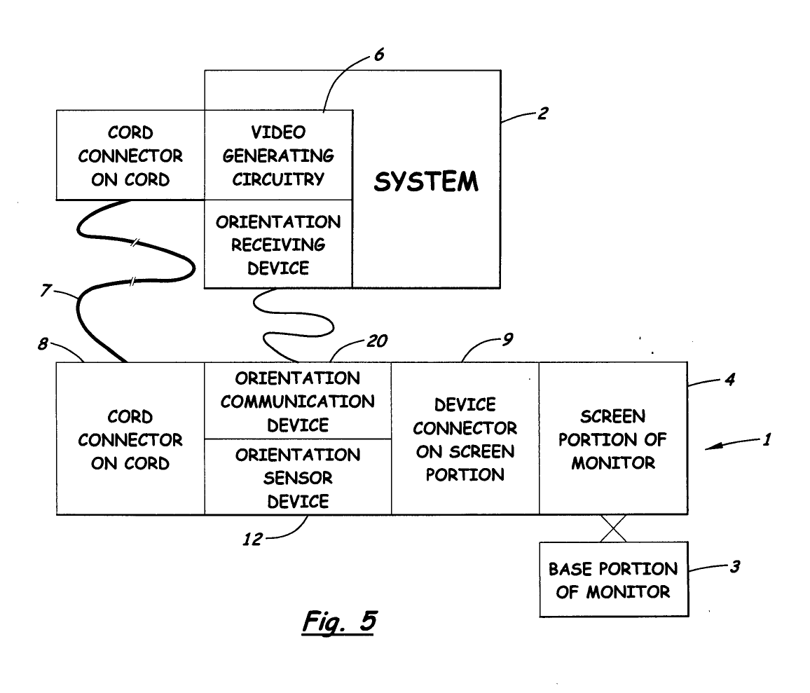

In other embodiments, a conductor or cable 22 that is separate from the video cable 7 may be employed as the orientation communication device 20 to carry the position signal to the video generating circuitry 6 (see, e.g., FIG. 5) of the information handling system 2. In such an embodiment, an orientation receiving device may be employed to receive the position signal and then transmit the signal to the video generating circuitry 6. For example, the conductor of the orientation communication device 20 could comprise a Universal Serial Bus (USB) compliant cable that is connected to a USB port on the information handling system, or a cable connected to a serial (RS-232) port on the information handling system. In some embodiments, the cable 7 may have a “Y” configuration, with a single end with first connector 16 connectable to the monitor 1 and a bifurcated portion located opposite of the first connector that includes a first branch with a video connector for connecting to the graphics card or video adapter for passing video signals, and second branch with a data and/or power connector for connecting to the information handling system 2 (such as through a USB connector).

Optionally, the orientation communication device 20 may comprise a wireless transmission device that transmits the position signal to a wireless transmission receiving device on the information handling system 2 (or in communication with the system 2) via, for example, Bluetooth or WiFi (802.11X) wireless transmission protocols, as well as those protocols developed and implemented in the future.

The orientation communication device 20 may provide one way communication from the orientation sensing device 12 to the video generating circuitry 6 for passing the position signal, or may optionally provide bi-directional communication between the orientation sensing device 12 and the video generating circuitry 6 for permitting, for example, orientation status inquiries to be passed from the video generating circuitry 6 to the orientation sensing device 12.

The transmission by the orientation communication device 20 of the position signal to the video generating circuitry 6 may occur on a continuous (or substantially continuous) basis, or may occur on an intermittent basis that is uniformly periodic. Optionally, the transmission of the position signal may be triggered by some activity or occurrence, such as through detection of the repositioning or reorientation of the screen portion 4 of the monitor 1, or the powering-up of the monitor 1 or the information handling system 2.

Upon receipt of the position signal by the video generating circuitry 6, which indicates that the orientation of the screen portion 3 has changed to a different position, the video generating circuitry 6 may then adapt or convert the video signals being sent to the monitor 1 to correspond to the new position. The signals generated by the circuitry 6 may remain the same until another change in the orientation is detected.

In an optional apparatus 24 of the invention, such as is shown in FIG. 8, the orientation sensing device 26 may be permanently integrated into the connector 8 of the cable 7, such as by molding the device in a unit with the connector 8 (see FIG. 8). Thus, the invention may be embodied as a video cable 7 that is connectable to the screen portion 4 of the monitor, and includes the features or characteristics of a conventional video cable 7 passing signals and/or power to the monitor 1. By positioning the orientation sensing device 12 in the cable connector adapted to connect to the monitor 1, the sensing device 12 is thus able to detect the position of the screen portion 4 as the connector is moved with the screen portion 4 as it is rotated. In a further optional embodiment, the orientation sensing device 12 may be a separate unit that is “piggybacked” on the cable connector 8, such as by physical attachment to the cable connector.

Those skilled in the art will recognize that the invention may be employed on apparatus other than monitors, and may be particularly useful on apparatus or appliances with cables that are movable or adjustable in position and that utilize cables for data transmission and/or power transmission.

It should also be recognized that the use of the invention is not dependent upon the presence of a base portion or pedestal of the monitor, as the device acts or senses at the point of attachment of the cable to the monitor, which typically is the portion of the monitor having the screen.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

I claim:

1. A device for sensing an orientation of a screen portion of a monitor comprising a base portion and a screen portion pivotally mounted on the base portion to permit pivoting of the screen portion with respect to the base portion, the device comprising:
a body;
a first connector located on the body and configured to connect to a connector on the screen portion of the monitor;
a second connector located on the body and configured to connect to a connector on a cable, the second connector being in communication with the first connector; and
an orientation sensing device mounted on the body and configured to sense an orientation of the body such that the orientation sensing device senses an orientation of the screen portion of the monitor when the first connector is connected to the connector on the screen portion of the monitor.

2. The device of claim 1 wherein the first connector and the second connector are configured to connect to connectors capable of passing video information.

3. The device of claim 1 wherein the orientation sensing device is configured to generate a position signal representative of the position of the screen portion of the monitor when the first connector is connected to the connector on the screen portion.

4. The device of claim 3 additionally comprising an orientation communication device configured to communicate an orientation sensed by the orientation sensing device to video generating circuitry.

5. The device of claim 1 wherein the orientation sensing device is configured to generate a position signal representative of the position of the screen portion of the monitor when the first connector is connected to the connector on the screen portion, and an orientation communication device configured to communicate the position signal to video generating circuitry.

6. The device of claim 1 wherein the orientation sensing device is configured to sense at least two different positions of rotation about an axis extending into a plane of a surface of a screen on the screen portion when the first connector is connected to the connector on the screen portion.

7. The device of claim 6 wherein the at least two positions includes positions that have at least approximately 90 degrees of rotation therebetween about an axis oriented perpendicular to a plane of a screen on the screen portion.

8. The device of claim 6 wherein the at least two positions includes a position corresponding to a landscape position of the screen portion of the monitor and a position corresponding to a portrait position of the screen portion of the monitor.

9. The device of claim 1 wherein the orientation sensing device is sensitive to gravity.

10. An information handling system capable of sensing an orientation of a screen displaying video generated by the system, comprising;
a monitor comprising a base portion and a screen portion having a display screen, the screen portion being pivotally mounted on the base portion to permit pivoting of the screen portion with respect to the base portion, the monitor having a monitor connector for receiving video signals;
video generating circuitry configured to generate a video signal to produce images on the display screen of the monitor;
a cable configured to carry a video signal, the cable being in communication with the video generating circuitry for receiving a video signal from the video generating circuitry, the cable having a cable connector configured to connect to the monitor connector of the monitor; and
a device for sensing an orientation of the screen portion of the monitor, the device comprising:
a body;
a first connector located on the body and connected to the monitor connector on the screen portion of the monitor;
a second connector located on the body and connected to the cable connector on the cable, the second connector being in electrical communication with the first connector for passing the video signal therebetween; and
an orientation sensing device mounted on the body and configured to sense an orientation of the body such that the orientation sensing device senses an orientation of the screen portion of the monitor when the first connector is connected to the connector on the screen portion of the monitor.

11. The system of claim 10 additionally comprising an orientation communication device configured to communicate an orientation sensed by the orientation sensing device to the video generating circuitry.

12. The system of claim 10 wherein the orientation sensing device is configured to generate a position signal representative of the position of the screen portion of the monitor when the first connector is connected to the connector on the screen portion, and an orientation communication device configured to communicate the position signal to video generating circuitry.

13. The system of claim 10 wherein the orientation sensing device is configured to sense at least two different positions of rotation about an axis extending into a plane of a surface of a screen on the screen portion when the first connector is connected to the connector on the screen portion.

14. A method of sensing an orientation of a display screen on a monitor having a base portion and a screen portion pivotally mounted on the base portion, the method comprising:
providing an apparatus comprising:
a body, a first connector located on the body, a second connector located on the body and being in communication with the first connector, and an orientation sensing device mounted on the body and configured to sense an orientation of the body;
connecting the first connector of the apparatus to a connector on the screen portion of the monitor;
connecting the second connector of the apparatus to a connector on a cable;
sensing a position of orientation of the screen portion of the monitor and generating a position signal; and
communicating the position signal to video generating circuitry configured to generate a video signal.

15. The method of claim 14 additionally comprising the step of altering the video signal generated by the video generating circuitry based upon the position signal.

16. The method of claim 14 additionally comprising detecting a change in the orientation of the screen portion of the monitor, sensing the position of the screen portion, and sending a position signal to the video generating circuitry indicating a change in the orientation.

17. The method of claim 14 wherein at least a portion of the step of communicating the position signal is performed over a wireless link between the orientation sensing device of the apparatus and the video generating circuitry.
